(19) United States
(12) Patent Application Publication
(10) Pub. No.: US 2026/0162363 A1
(43) Pub. Date: Jun. 11, 2026

(54) HIGH-PRECISION THREE-DIMENSIONAL GEOMETRY RECONSTRUCTION METHOD USING MULTI-VIEW RGBD DATA AND APPARATUS FOR THE SAME

(71) Applicant: ELECTRONICS AND TELECOMMUNICATIONS RESEARCH INSTITUTE, Daejeon (KR)

(72) Inventors: Hye-Sun KIM, Daejeon (KR); Kyung-Kyu KANG, Daejeon (KR); Youn-Hee GIL, Daejeon (KR); Seong-Min BAEK, Daejeon (KR); Cho-Rong YU, Daejeon (KR); Sung-Jin HONG, Daejeon (KR)

(73) Assignee: ELECTRONICS AND TELECOMMUNICATIONS RESEARCH INSTITUTE, Daejeon (KR)

(21) Appl. No.: 19/406,230

(22) Filed: Dec. 2, 2025

(30) Foreign Application Priority Data
Dec. 5, 2024 (KR) 10-2024-0179878
Nov. 7, 2025 (KR) 10-2025-0167275

(51) Int. Cl. G06T 17/00; G06T 5/60; G06T 5/73

(52) U.S. Cl. CPC G06T 17/00; G06T 5/60; G06T 5/73

(57) ABSTRACT

Disclosed herein are a high-precision three-dimensional (3D) geometry reconstruction method using multi-view RGBD data and an apparatus for the same. The high-precision three-dimensional (3D) geometry reconstruction method is performed by a high-precision three-dimensional (3D) geometry reconstruction apparatus, and includes obtaining multi-view RGBD data by capturing a reconstruction target, estimating initial reconstruction information in real time using the multi-view RGBD data, performing blur removal, camera position/pose precision enhancement, and 3D geometry precision enhancement based on pre-trained multiple deep learning models, thus enhancing precision of the initial reconstruction information, and performing 3D rendering or mesh conversion on precision-enhanced reconstruction information, and storing 3D-rendered or mesh-converted reconstruction information.

### CROSS REFERENCE TO RELATED APPLICATIONS

This application claims the benefit of Korean Patent Application Nos. 10-2024-0179878, filed Dec. 5, 2024 and 10-2025-0167275, filed Nov. 7, 2025, which are hereby incorporated by reference in their entireties into this application.

### BACKGROUND OF THE INVENTION

### 1. Technical Field

The present disclosure relates to a high-precision three-dimensional (3D) geometry reconstruction technology using multi-view RGBD data, and more particularly to a technology for integrating RGBD data collected from various angles and positions, thus reconstructing a significantly more precise and accurate 3D space, rather than merely using two-dimensional (2D) images or distance information alone.

### 2. Description of the Related Art

Because a conventional 3D reconstruction technology using Red, Green, Blue-Depth (RGBD) data mainly employs a handheld-type depth camera, it has been utilized to reconstruct an object or an indoor space within a short period of time. This scheme is characterized in that RGB data and depth data are collected while moving the depth camera at various angles, and are processed in real time, thus reconstructing a 3D space.

However, this scheme has several limitations. First, in a process of estimating the position and pose (orientation) of the camera, computational errors frequently occur. In particular, in complicated indoor spaces or various lighting conditions, it is difficult to estimate the accurate position and pose of the camera, and thus reconstruction quality may be deteriorated. Second, depth values are inaccurate or have low resolution due to technical limitations of the depth camera itself, and thus the depth camera is unsuitable for reconstructing fine spatial structures. These problems may degrade the quality of the final output in a process of performing 3D space reconstruction in real time. Due thereto, the depth camera can be used to simply determine space information or schematically perform 3D rendering, but it has limitation in utilizing the output as high-precision 3D reconstructed data.

On the other hand, a 3D precise reconstruction technology using multi-view images is composed of several steps of complicated computing pipelines, such as a process of accurately extracting multiple feature points from an image and matching the feature points, a process of estimating the position and pose of a camera through the matched feature points, and a process of calculating precise depth values based on multiple viewpoints. Although this scheme can reconstruct 3D geometry with much higher precision than real-time reconstruction technologies, substantial computation time and resources are required. Due to these characteristics, there are limitations in utilizing the scheme in a lightweight and immediate manner in various application fields.

These two existing technologies have their own inherent advantages and disadvantages. That is, the real-time 3D reconstruction technology may promptly derive results, but it is limited in reconstruction accuracy and quality. Further, although a multi-view-based precise reconstruction technology provides high accuracy and reconstruction quality, fields to which this technology is applicable are limited due to a long computation time thereof.

For these reasons, there is a need to develop new techniques suitable for 3D geometry reconstruction that requires both high precision and fast processing.

### PRIOR ART DOCUMENTS

### Patent Documents

(Patent Document 1) Korean Patent Application Publication No. 10-2019-0080641, Publication Date: Jul. 8, 2019 (Title: Method for Indoor Reconstruction)

### SUMMARY OF THE INVENTION

Accordingly, the present disclosure has been made keeping in mind the above problems occurring in the prior art, and an object of the present disclosure is to provide a technical pipeline, which scans an object or a space from multiple viewpoints by utilizing a device for capturing RGBD data by which image information and distance information can be simultaneously collected, and which reconstructs high-precision 3D geometry within a short time based on the scanned object or space.

Another object of the present disclosure is to reconstruct a 3D space with far greater precision and accuracy than a technology that merely uses only 2D images or distance information.

A further object of the present disclosure is to solve degradation in reconstruction quality in conventional technologies by adding a pipeline for enhancing the precision of reconstruction results using deep learning.

Yet another object of the present disclosure is to acquire precise 3D reconstruction data without needing to wait for a long time by applying deep learning models which provide fast computation and high reconstruction accuracy.

In accordance with an aspect of the present disclosure to accomplish the above objects, there is provided a high-precision three-dimensional (3D) geometry reconstruction method, including by a high-precision 3D geometry reconstruction apparatus, obtaining multi-view RGBD data by capturing a reconstruction target; estimating initial reconstruction information in real time using the multi-view RGBD data; enhancing precision of the initial reconstruction information by performing blur removal, camera position/pose precision enhancement, and 3D geometry precision enhancement based on pre-trained multiple deep learning models; and performing 3D rendering or mesh conversion on precision-enhanced reconstruction information, and storing 3D-rendered or mesh-converted reconstruction information.

The multi-view RGBD data may correspond to data, obtained by capturing an object or a space corresponding to the reconstruction target at various angles and positions, based on a depth camera capable of capturing RGBD data.

The initial reconstruction information may include 3D initial position/pose information of the depth camera and scene graph information.

The pre-trained multiple deep learning models may include a deblur deep learning model configured to remove blurring in the multi-view RGBD data, a camera position/pose precision enhancement deep learning model configured to correct a camera position and pose by entirely utilizing the multi-view RGBD data, and a Gaussian optimization deep learning model configured to enhance precision of 3D reconstructed geometry using a result of 3D Gaussian rendering.

The camera position/pose precision enhancement deep learning model may correct a camera position transformation matrix such that a sum of losses produced by a loss function between nodes of the scene graph information is minimized.

The camera position transformation matrix may be a matrix that projects an N-th camera coordinate system corresponding to camera position/pose information of N-th RGBD input data onto an (N+1)-th camera coordinate system corresponding to camera position/pose information of (N+1)-th RGBD input data.

The loss function may be set such that a value matching the (N+1)-th RGBD input data is obtained by multiplying the camera position transformation matrix by the N-th RGBD input data.

The Gaussian optimization deep learning model may repeatedly perform operations of converting the multi-view RGBD data into a Gaussian, generating a 3D Gaussian by flattening the Gaussian along a normal direction, and optimizing a Gaussian parameter so that a result of rendering the 3D Gaussian becomes similar to the multi-view RGBD data.

The Gaussian parameter may include a position, a color, a rotation value for determining orientation of placement, size values along X, Y, and Z axes, and a density value for transparency.

In accordance with another aspect of the present disclosure to accomplish the above objects, there is provided a high-precision three-dimensional (3D) geometry reconstruction apparatus, including a processor configured to obtain multi-view RGBD data by capturing a reconstruction target, estimate initial reconstruction information in real time using the multi-view RGBD data, enhance precision of the initial reconstruction information by performing blur removal, camera position/pose precision enhancement, and 3D geometry precision enhancement based on pre-trained multiple deep learning models, perform 3D rendering or mesh conversion on precision-enhanced reconstruction information, and store 3D-rendered or mesh-converted reconstruction information; and a memory configured to store the pre-trained multiple deep learning models and the 3D-rendered or mesh-converted reconstruction information.

The multi-view RGBD data may correspond to data, obtained by capturing an object or a space corresponding to the reconstruction target at various angles and positions, based on a depth camera capable of capturing RGBD data.

The initial reconstruction information may include 3D initial position/pose information of the depth camera and scene graph information.

The pre-trained multiple deep learning models may include a deblur deep learning model configured to remove blurring in the multi-view RGBD data, a camera position/pose precision enhancement deep learning model configured to correct a camera position and pose by entirely utilizing the multi-view RGBD data, and a Gaussian optimization deep learning model configured to enhance precision of 3D reconstructed geometry using a result of 3D Gaussian rendering.

The camera position/pose precision enhancement deep learning model may correct a camera position transformation matrix such that a sum of losses produced by a loss function between nodes of the scene graph information is minimized.

The camera position transformation matrix may be a matrix that projects an N-th camera coordinate system corresponding to camera position/pose information of N-th RGBD input data onto an (N+1)-th camera coordinate system corresponding to camera position/pose information of (N+1)-th RGBD input data.

The loss function may be set such that a value matching the (N+1)-th RGBD input data is obtained by multiplying the camera position transformation matrix by the N-th RGBD input data.

The Gaussian optimization deep learning model may repeatedly perform operations of converting the multi-view RGBD data into a Gaussian, generating a 3D Gaussian by flattening the Gaussian along a normal direction, and optimizing a Gaussian parameter so that a result of rendering the 3D Gaussian becomes similar to the multi-view RGBD data.

The Gaussian parameter may include a position, a color, a rotation value for determining orientation of placement, size values along X, Y, and Z axes, and a density value for transparency.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are diagrams illustrating an example of 3D precise reconstruction using RGBD data according to the present disclosure;

FIG. 3 is an operation flowchart illustrating a high-precision 3D geometry reconstruction method using multi-view RGBD data according to an embodiment of the present disclosure;

FIG. 4 is an operation flowchart illustrating in detail the high-precision 3D geometry reconstruction method illustrated in FIG. 3;

FIG. 5 is a diagram illustrating an example of a real-time camera position/pose estimation process according to the present disclosure;

FIG. 6 is a diagram illustrating an example of a blur-removal process using a deblur deep learning model according to the present disclosure;

FIG. 7 is a diagram illustrating an example of real-time camera position/pose estimation error;

FIG. 8 is a diagram illustrating an example of a process of operating a deep learning model for enhancing camera position/pose precision according to the present disclosure;

FIG. 9 is a diagram illustrating an example in which repetitive operations are performed while sequentially traversing a scene graph in a deep learning model for enhancing camera position/pose precision according to the present disclosure;

FIGS. 10 and 11 are diagrams illustrating a 3D Gaussian and an example of a space represented by a Gaussian set according to the present disclosure;

FIG. 12 is a diagram illustrating an example of a 3D Gaussian converted along a normal direction according to the present disclosure; and

FIG. 13 is a diagram illustrating a high-precision 3D geometry reconstruction apparatus using multi-view RGBD data according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Three-dimensional (3D) reconstruction using RGBD data captured by a depth camera had various limitations in utilizing the reconstructed 3D data of objects and spaces, due to issues such as degraded precision resulting from real-time-oriented processing, or excessively long processing times required to enhance precision.

The present disclosure is intended to propose a pipeline that obtains initial values for camera information through a real-time camera position/pose estimation technology to reduce processing time and that utilizes a 3D Gaussian and a deep learning model to enhance reconstruction precision.

In detail, the present disclosure relates to a technology that reconstructs 3D geometry in real time using multi-view RGBD data and performs high-precision reconstruction using various pre-trained deep learning models to enhance precision. The 3D geometry reconstructed in this way may be utilized as important base data in various industrial fields.

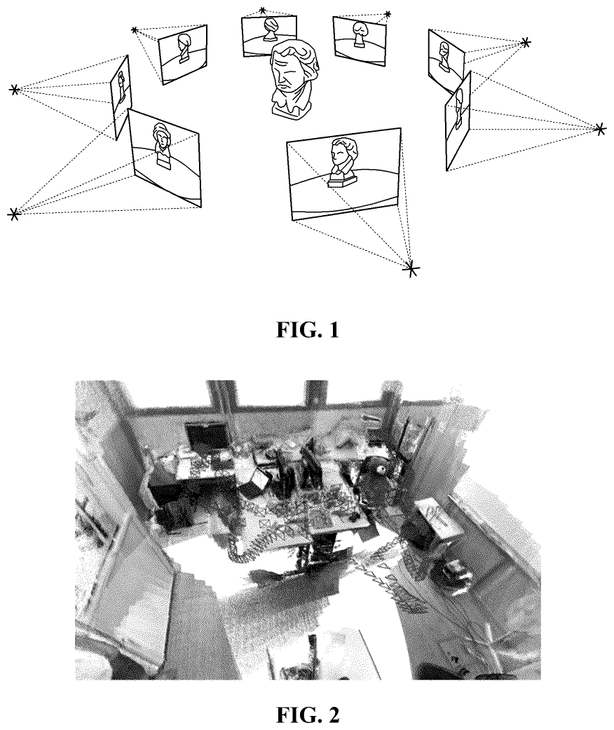

For example, as illustrated in FIGS. 1 and 2, 3D object scanning may be used to exactly reproduce real objects or spaces in a digital form, and thus the 3D object scanning may be utilized in product design, quality inspection, architecture, and design fields. Further, in the field of immersive Virtual Reality (VR) content production, high-quality 3D spatial data is required so that users can experience a sense of space similar to that of the real world in a virtual environment. This content plays a key role in providing immersive experiences across various fields such as education, gaming and entertainment. Furthermore, the reconstructed 3D geometry may also be applied to a digital clone technology. A digital clone is a technology that identically reproduces real persons or objects in a virtual environment, and is essential for virtual simulation and visualization in fields such as healthcare, fashion, and film industry.

Hereinafter, embodiments of the present disclosure will be described in detail with reference to the attached drawings.

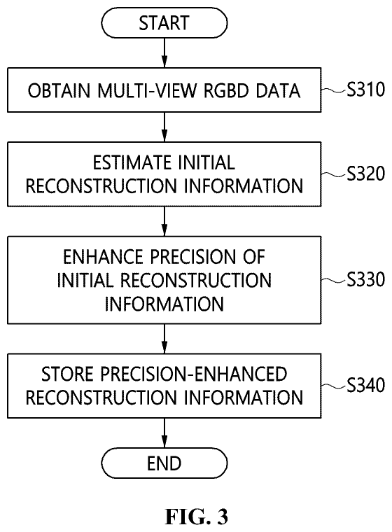

FIG. 3 is an operation flowchart illustrating a high-precision 3D geometry reconstruction method using multi-view RGBD data according to an embodiment of the present disclosure.

Referring to FIG. 3, in the high-precision 3D geometry reconstruction method using multi-view RGBD data according to the embodiment of the present disclosure, a high-precision 3D geometry reconstruction apparatus obtains multi-view RGBD data by capturing a reconstruction target at step S310.

Here, the multi-view RGBD data may correspond to data, obtained by capturing an object or a space corresponding to the reconstruction target at various angles and positions, based on a depth camera capable of capturing RGBD data.

For example, a target object or space may be scanned so that RGBD data from various angles toward the target object or space desired to be reconstructed in 3D may be sufficiently acquired through a hand-held scanning scheme.

Here, a process of obtaining the multi-view RGBD data may correspond to an initial reconstruction information generation stage in the high-precision 3D geometry reconstruction process according to the present disclosure.

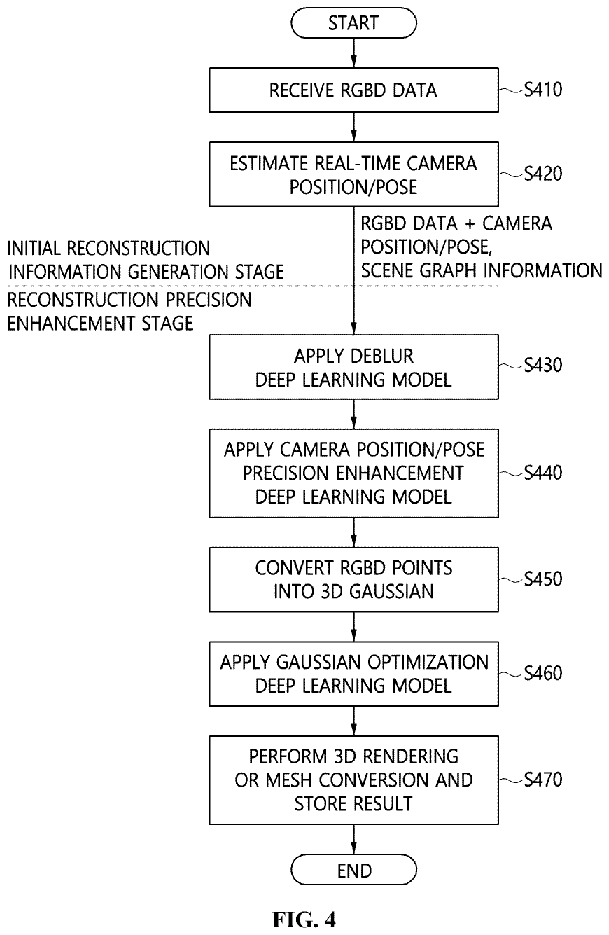

For example, FIG. 4 is an operation flowchart illustrating in detail a high-precision 3D geometry reconstruction method according to the present disclosure, wherein the method is broadly divided into an initial reconstruction information generation stage and a reconstruction precision enhancement stage. Referring to FIG. 4, a process of receiving multi-view RGBD data at step S410 may correspond to the initial reconstruction information generation stage.

Further, referring to FIG. 3, in the high-precision 3D geometry reconstruction method using multi-view RGBD data according to the embodiment of the present disclosure, the high-precision 3D geometry reconstruction apparatus estimates initial reconstruction information in real time using the multi-view RGBD data at step S320.

Here, the initial reconstruction information may include the 3D initial position/pose information and scene graph information of the depth camera.

Referring to FIG. 4, the process of estimating the initial reconstruction information may be a process of estimating the real-time position/pose of the camera at step S420, and may correspond to the initial reconstruction information generation stage.

In this process, 3D camera position/pose information and the entire scene graph information, which are obtained fast, but have slightly low precision, may be acquired using a conventional real-time 3D reconstruction technology based on RGBD data. Here, a process of receiving RGBD data, obtained by evenly scanning the object or space corresponding to the reconstruction target, and sequentially calculating the capture position and pose of the depth camera is performed. To realize fast computational speed, a technique for extracting and matching lightweight feature points is applied. That is, because a technique for extracting and accurately matching a large number of feature points requires a lot of computation time, the use of the technique may be avoided at the step of generating the initial reconstruction information in the present disclosure.

In this case, although an operation of estimating camera position/pose in real time is performed, performance optimization based on scene graph generation and loop closing check may be performed within a range which does not impose a burden on processing time.

For example, a correlation between sequential camera inputs may be represented by a graph, and whether a loop occurs in the graph is continuously checked, thus preventing errors from being accumulated while enhancing the entire accuracy. Here, each node in the scene graph represents the camera position and pose information at a specific capture time, and an edge is connected when there is view overlap between cameras or when a correlation exists between the cameras. Therefore, such a scene graph structure may provide the context of the entire scene, and may enable the relationship between the movement of the camera and the space to be systematically managed during a 3D reconstruction process.

Such initial reconstruction information may be used as an important input value at the subsequent reconstruction precision enhancement stage, and may provide a foundation for achieving higher-level reconstruction.

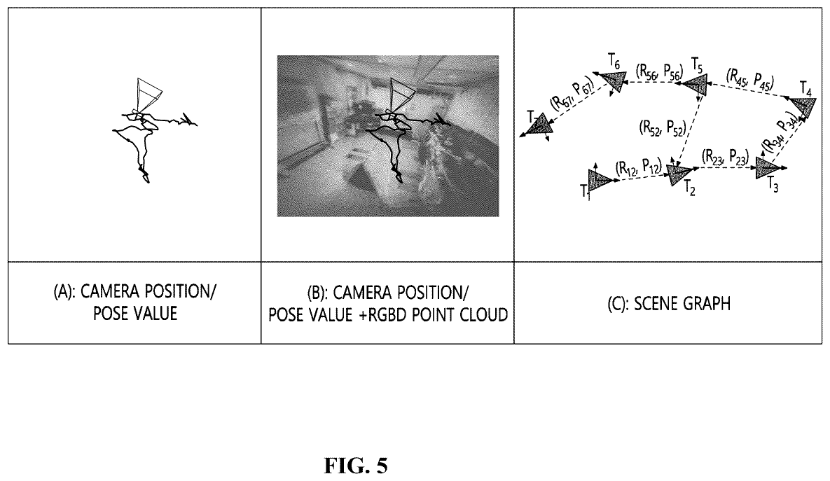

FIG. 5 illustrates camera position/pose information estimated using the real-time 3D reconstruction technology using RGBD data and an example of a scene graph generated through the camera position/pose information in the real-time camera position/pose estimation process (S420) illustrated in FIG. 4.

For example, (a) illustrated in FIG. 5 represents changes in position/pose values caused by the movement of a camera, and (b) represents the result of rendering the input RGBD data together in the form of a 3D point cloud. Further, the scene graph in (c) represents camera position/pose information at respective capture times by the cameras by nodes and connects mutual relationships between cameras at respective positions by edges, thus visually showing the entire spatial structure.

Furthermore, referring to FIG. 3, in the high-precision 3D geometry reconstruction method using multi-view RGBD data according to the embodiment of the present disclosure, the high-precision 3D geometry reconstruction apparatus performs blur-removal, camera position/pose precision enhancement, and 3D geometry precision enhancement based on pre-trained multiple deep learning models, thus enhancing the precision of the initial reconstruction information at step S330.

Here, the pre-trained multiple deep learning models may include a deblur deep learning model configured to remove blurring in the multi-view RGBD data, a camera position/pose precision enhancement deep learning model configured to correct the camera position and pose by entirely utilizing the multi-view RGBD data, and a Gaussian optimization deep learning model configured to enhance the precision of 3D reconstructed geometry using the results of 3D Gaussian rendering.

In this case, the camera position/pose precision enhancement deep learning model may correct a camera position transformation matrix such that the sum of losses produced by the loss function between nodes of the scene graph information is minimized.

Here, the camera position transformation matrix may be a matrix that projects an N-th camera coordinate system corresponding to the camera position/pose information of N-th RGBD input data onto an (N+1)-th camera coordinate system corresponding to camera position/pose information of (N+1)-th RGBD input data.

Here, the loss function may be set such that a value matching the (N+1)-th RGBD input data is obtained by multiplying the camera position transformation matrix by the N-th RGBD input data.

Here, the Gaussian optimization deep learning model may repeatedly perform operations (computations) of converting multi-view RGBD data into a Gaussian, generating a 3D Gaussian by flattening the Gaussian along the normal direction, and optimizing Gaussian parameters so that the result of rendering the 3D Gaussian becomes similar to the multi-view RGBD data.

Here, the Gaussian parameters may include a position, a color, a rotation value that determines an orientation of placement, size values along X, Y, and Z axes, and a density value representing transparency.

Referring to FIG. 4, the process of enhancing the precision of the initial reconstruction information may correspond to a process ranging from step S430 to step S470, wherein a technical pipeline may be configured to enhance the precision of 3D reconstruction results using the input multi-view RGBD data and the results processed at step S410 and step S420.

In detail, the pipeline may be configured to include a process S430 of removing blurring, which hinder improvement in computational accuracy, by applying the deblur deep learning model, a process S440 of improving the accuracy of camera position/pose information values with significant errors by applying the camera position/pose precision-enhancement deep learning model, a process S450 of converting RGBD points into a 3D Gaussian, a process S460 of enhancing the accuracy of the final 3D reconstructed geometry by applying the Gaussian optimization deep learning model, and a process S470 of performing 3D rendering or mesh conversion on precision-enhanced reconstruction information, and storing the 3D-rendered or mesh-converted reconstruction information.

In each process, faster and more accurate deep learning models than the conventional non-real-time 3D precise reconstruction technology may be utilized.

Hereinafter, processes for respective steps ranging from step S430 to step S460 illustrated in FIG. 4 will be described in detail.

First, at step S430 of applying the deblur deep learning model, blurring occurring in an input RGB image may be removed.

This process may correspond to a preprocessing process performed on the input RGB image so as to effectively utilize the deep learning model for 3D space reconstruction.

Here, blurring (i.e., blur artifacts) may occur frequently when collecting RGBD data while moving each camera in a hand-held manner, and may refer to a situation in which objects or spaces cannot be clearly captured when the camera moves quickly or shakes. Although such blurring has often been regarded as an outlier and ignored in conventional techniques, it may act as a critical error in the process in which a deep learning model learns RGB images. That is, when the deep learning model learns space reconstruction based on the input data, distorted information caused by blurring may be provided as ground-truth input, thereby causing noise in the learning process and resulting in performance degradation.

In this case, the simplest method for preventing blurring is to perform capturing while slowly moving the camera, but this method may cause inconvenience to a user due to increased capture time.

To solve this inconvenience, the present disclosure proposes a method of adding a pre-trained deblur deep learning model as a two-stage input data preprocessing procedure.

The deblur deep learning model according to the present disclosure may promptly and effectively remove blurring in an input RGB image 610, and thereafter provide a deblurred RGB image 620, as illustrated in FIG. 6. This may correspond to a preprocessing procedure that provides clear data which can be learned by deep learning models for subsequent space reconstruction optimization.

In addition, this deblur scheme may contribute to decreasing constraints in a capturing process and maximizing learning efficiency of models.

Further, at step S440 of applying the camera position/pose precision enhancement deep learning model, processing may be accurately performed once more by correcting computing errors that could not be processed yet due to limitation in real-time processing.

That is, step S440 may correspond to a process of enhancing the precision of camera position/pose information obtained at step S420.

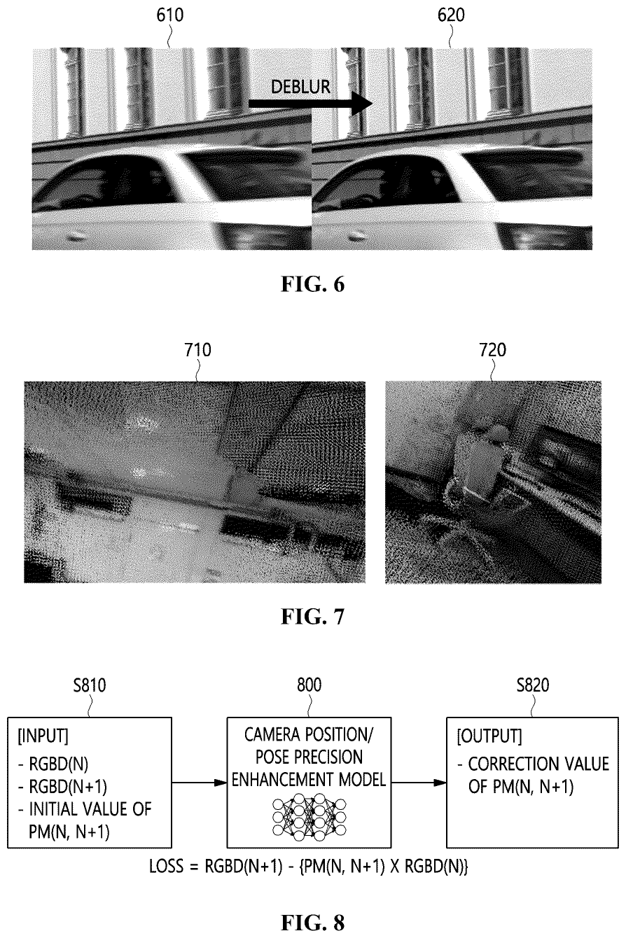

For example, FIG. 7 illustrates real-time camera position/pose estimation error results 710 and 720 in the form of 3D point clouds generated with RGBD data.

Referring to FIG. 7, it can be seen that erroneous camera information has been estimated due to insufficient matching information between images attributable to the use of lightweight feature points and insufficient overall computation attributable to real-time characteristics.

In conventional technologies, a bundle adjustment method was used as a method for correcting camera position/pose information. However, this method uses lightweight feature point information, and thus there is a limitation in enhancing precision.

Therefore, the present disclosure is intended to propose the camera position/pose precision enhancement deep learning model, which uses the concept illustrated in FIG. 8 as a basic loss function.

For example, referring to FIG. 8, RGBD(N), which is N-th RGBD input data, and RGBD(N+1), which is (N+1)-th RGBD input data, may be target data. In this case, because the camera position/pose information previously obtained at step S420 of FIG. 4 is known as a matrix value, a matrix PM(N, N+1) for projecting an N-th camera coordinate system onto an (N+1)-th camera coordinate system may be easily obtained.

Therefore, a camera position/pose precision enhancement deep learning model 800 according to the present disclosure may receive RGBD(N), RGBD(N+1), and an initial value of PM(N, N+1) as input at step S810, and may output a correction value of PM(N, N+1) at step S820.

Here, the loss function may be set such that a value almost identical to RGBD(N+1) is output by multiplying PM(N, N+1) by RGBD(N), and thus an accurate correction value of PM(N, N+1) may be inferred.

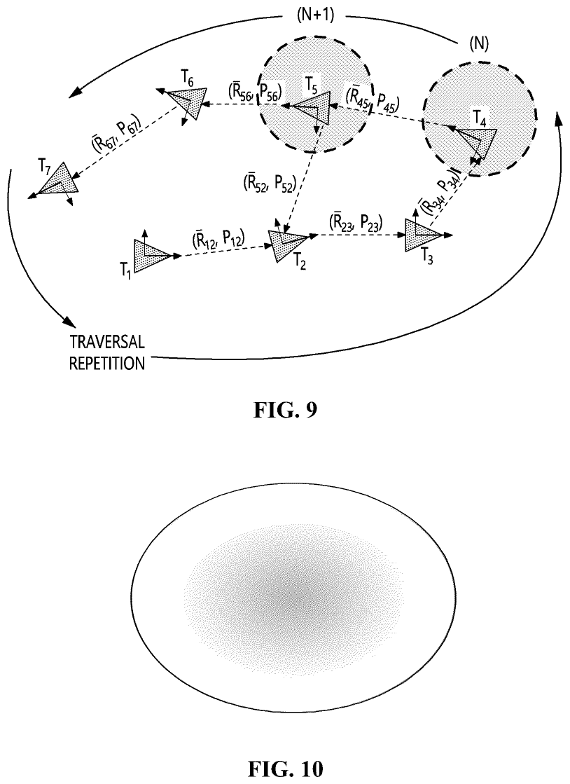

In this case, as illustrated in FIG. 9, the camera position/pose precision enhancement deep learning model 800 may set two nodes connected by an edge as input data (N) and (N+1), respectively, and perform repetitive operations while sequentially traversing a scene graph. Finally, when the sum of losses produced by the loss function between individual nodes of the scene graph becomes a minimum value, the estimation of the camera position/pose precision enhancement deep learning model 800 may be terminated. Thereafter, the matrix PM(N, N+1) of FIG. 8 may be easily converted again into camera position/pose matrix values at respective nodes.

In this way, since the camera position/pose precision enhancement process proposed in the present disclosure performs correction on the entire RGBD input data rather than the lightweight feature points, errors attributable to insufficient feature information may be corrected. Further, because such a process is implemented through the deep learning model that utilizes a high performance GPU, there is an advantage in that an accurate correction value may be acquired within a short period of time.

Furthermore, at step S460 of applying the Gaussian optimization deep learning model after the RGBD points are converted into the 3D Gaussian at step S450, a process of enhancing the precision of the 3D reconstructed geometry based on the camera position/pose information enhanced at step S440 may be performed. In this procedure, processing of converting the input RGBD data into a 3D Gaussian form and enhancing the precision of geometry may be performed. That is, even if the camera position/pose information is enhanced, depth measurement errors of the depth camera may remain without change, and thus the process corresponding to steps S450 and S460 is essentially required.

First, the process S450 of converting RGBD points into the 3D Gaussian may correspond to a process of converting multi-view RGBD data into a 3D Gaussian form.

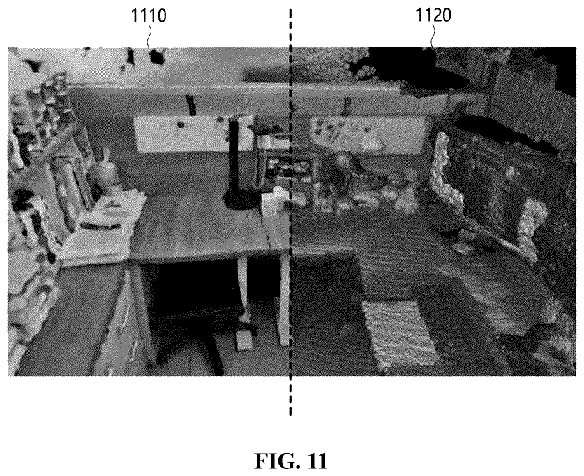

Here, the Gaussian may refer to a 3D ellipsoid having transparency values, as illustrated in FIG. 10. Here, when the RGBD data is converted into a Gaussian with definable volume, transparency, and shape, rather than into fixed-size points, a denser 3D geometric representation may be achieved.

For example, FIG. 11 illustrates an example in which space is represented by a 3D Gaussian map, wherein a typical rendering result 1110 and an opaque rendering result 1120 are shown to be compared with each other so as to check the shape and size of a Gaussian.

However, when RGBD data is converted into a 3D Gaussian, a process of optimizing the Gaussian is required in order to facilitate a subsequent Gaussian map precision enhancement process.

Here, the Gaussian is determined by Gaussian parameters corresponding to a position, a color, a rotation value that determines an orientation of placement, size values along X, Y, and Z axes, and a density value for transparency, and a method for determining these Gaussian parameters is shown in the following Table 1.

TABLE 1

| Gaussian Parameter | Determination Method |
|---|---|
| Position | (x, y, z) values calculated using the depth |
| | values of RGBD data and the camera |
| | position/pose information |
| Color | RGB color values of RGBD data |
| Rotation | Rotation in the direction of a normal vector |
| | calculated from the depth map of RGBD data |
| Size | Size of {depth map interval size × random |
| | value}, but size flattened along a normal |
| | vector direction |
| Density | Opacity value, representing opaque surface |
| | information detected by the depth camera |

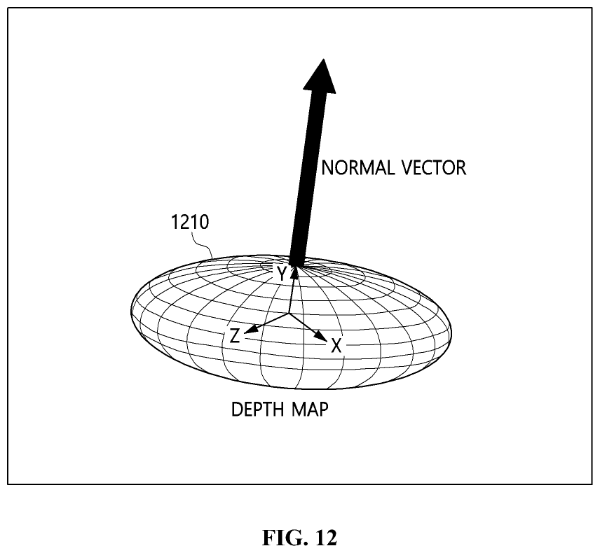

Here, because the RGBD data has a map format, a normal vector for each of Gaussians may be calculated through depth map information. As illustrated in FIG. 12, when a 3D Gaussian 1210 is converted into a rounded and flattened shape along the normal direction, the surface information of the depth map may be represented with relatively high fidelity. Here, applying a random transformation value to the size of the basic Gaussian may provide assistance in reducing the number of Gaussians upon performing processing for Gaussian map optimization.

Furthermore, at step S460, the positions, colors, rotation, sizes, and density values of 3D Gaussians may be optimized by applying a deep learning framework.

Here, the loss function of the Gaussian optimization deep learning model may correspond to {RGB data(image)−3D rendering result of Gaussians}, and an operation of optimizing Gaussian parameters to allow the input and the Gaussian rendering result to be as similar to each other as possible may be repeatedly performed.

For example, in the initial stage of repetitive operations of the Gaussian optimization deep learning model, a sufficient number of Gaussians generated using RGBD data are already present, and thus the repetitive operations may be induced to reduce the number of Gaussians while adjusting Gaussian parameters. In this case, transformation is already applied to the size of Gaussians, and thus a scheme for removing Gaussians, the size of which is decreased and the density of which is lowered, while optimizing respective Gaussians with each other may be applied.

After the number of Gaussians is sufficiently reduced in this way, a process of adding a new Gaussian may be performed. The reason for this may be to precisely reconstruct a transparent object, a reflective object, a thin and slim object, or the like which cannot be detected by the depth camera.

By means of this process, 3D geometry errors that may occur due to insufficient and inaccurate depth information may be corrected, and Gaussians may be reconstructed and generated using precise Gaussian information.

Furthermore, referring to FIG. 3, in the high-precision 3D geometry reconstruction method using multi-view RGBD data according to the embodiment of the present disclosure, the high-precision 3D geometry reconstruction apparatus performs 3D rendering or mesh conversion on the precision-enhanced reconstruction information, and stores the 3D-rendered or mesh-converted reconstruction information at step S340.

This process may correspond to step S470 in the reconstruction precision enhancement stage illustrated in FIG. 4, and the precisely reconstructed Gaussians may be 3D-rendered or converted into a mesh and stored so that they are utilized for XR content or typical applications.

By means of this high-precision 3D geometry reconstruction method, high-precision 3D geometry may be reconstructed within a short period of time.

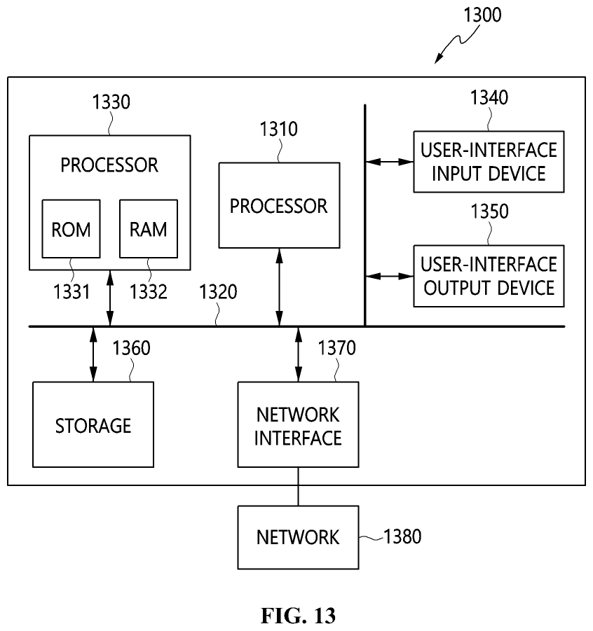

FIG. 13 is a diagram illustrating a high-precision 3D geometry reconstruction apparatus using multi-view RGBD data according to an embodiment of the present disclosure.

Referring to FIG. 13, the high-precision 3D geometry reconstruction apparatus using multi-view RGBD data according to the embodiment of the present disclosure may be implemented in a computer system such as a computer-readable storage medium. As illustrated in FIG. 13, a computer system 1300 may include one or more processors 1310, memory 1330, a user input device 1340, a user output device 1350, and a storage 1360, which communicate with each other through a bus 1320. The computer system 1300 may further include a network interface 1370 connected to a network 1380. Each processor 1310 may be a Central Processing Unit (CPU) or a semiconductor device for executing programs or processing instructions stored in the memory 1330 or the storage 1360. Each of the memory 1330 and the storage 1360 may be any of various types of volatile or nonvolatile storage media. For example, the memory 1330 may include Read-Only Memory (ROM) 1331 or Random Access Memory (RAM) 1332.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

Each processor 1310 may obtain multi-view RGBD data by capturing a reconstruction target.

Here, the multi-view RGBD data may correspond to data, obtained by capturing an object or a space corresponding to a reconstruction target at various angles and positions, based on a depth camera capable of capturing RGBD data.

Further, the processor 1310 may estimate initial reconstruction information in real time using the multi-view RGBD data.

Here, the initial reconstruction information may include the 3D initial position/pose information and scene graph information of the depth camera.

Also, the processor 1310 may perform blur removal, camera position/pose precision enhancement, and 3D geometry precision enhancement based on pre-trained multiple deep learning models, thus enhancing the precision of the initial reconstruction information.

Here, the pre-trained multiple deep learning models may include a deblur deep learning model configured to remove blurring in the multi-view RGBD data, a camera position/pose precision enhancement deep learning model configured to correct the camera position and pose by entirely utilizing the multi-view RGBD data, and a Gaussian optimization deep learning model configured to enhance the precision of 3D reconstructed geometry using the results of 3D Gaussian rendering.

In this case, the camera position/pose precision enhancement deep learning model may correct a camera position transformation matrix so that the sum of losses produced by the loss function between nodes of the scene graph information is minimized.

Here, the camera position transformation matrix may be a matrix that projects an N-th camera coordinate system corresponding to the camera position/pose information of N-th RGBD input data onto an (N+1)-th camera coordinate system corresponding to camera position/pose information of (N+1)-th RGBD input data.

Here, the loss function may be set such that a value matching the (N+1)-th RGBD input data is obtained by multiplying the camera position transformation matrix by the N-th RGBD input data.

Here, the Gaussian optimization deep learning model may repeatedly perform operations of converting multi-view RGBD data into a Gaussian, generating a 3D Gaussian by flattening the Gaussian along the normal direction, and optimizing Gaussian parameters so that the result of rendering the 3D Gaussian becomes similar to the multi-view RGBD data.

Here, the Gaussian parameters may include a position, a color, a rotation value that determines an orientation of placement, size values along X, Y, and Z axes, and a density value representing transparency.

Furthermore, the processor 1310 performs 3D rendering or mesh conversion on the reconstruction information, the precision of which has been enhanced, and stores the result of 3D rendering or mesh conversion.

The memory 1330 stores pre-trained multiple deep learning models and 3D rendered or mesh-converted reconstruction information.

Here, because the detailed operating process of the high-precision 3D geometry reconstruction apparatus according to an embodiment of the present disclosure has been described in detail with reference to FIGS. 3 to 12, description thereof will be omitted.

By utilizing this high-precision 3D geometry reconstruction apparatus, high-precision 3D geometry may be reconstructed within a short period of time.

According to the present disclosure, there can be provided an essential base technology that may utilize the same 3D data as real data in various fields through a technology for scanning a multi-view space and reconstructing high-precision 3D geometry using RGBD data.

Further, the present disclosure may maintain fast computational speed by utilizing a real-time technology and a fast computing deep learning framework while enhancing the precision of reconstruction results by applying a deep learning model that references the entire RGBD data.

Furthermore, the present disclosure may maximize the efficiency of a deep learning model by correcting blur errors of an RGBD image utilized as a ground truth value (data) for deep learning.

As described above, in the high-precision 3D geometry reconstruction method using multi-view RGBD data and the apparatus for the high-precision 3D geometry reconstruction method according to the present disclosure, the configurations and schemes in the above-described embodiments are not limitedly applied, and some or all of the above embodiments can be selectively combined and configured such that various modifications are possible.

What is claimed is:

1. A high-precision three-dimensional (3D) geometry reconstruction method, comprising:
by a high-precision 3D geometry reconstruction apparatus,
obtaining multi-view RGBD data by capturing a reconstruction target;
estimating initial reconstruction information in real time using the multi-view RGBD data;
enhancing precision of the initial reconstruction information by performing blur removal, camera position/pose precision enhancement, and 3D geometry precision enhancement based on pre-trained multiple deep learning models; and
performing 3D rendering or mesh conversion on precision-enhanced reconstruction information, and storing 3D-rendered or mesh-converted reconstruction information.

2. The high-precision 3D geometry reconstruction method of claim 1, wherein the multi-view RGBD data corresponds to data, obtained by capturing an object or a space corresponding to the reconstruction target at various angles and positions, based on a depth camera capable of capturing RGBD data.

3. The high-precision 3D geometry reconstruction method of claim 2, wherein the initial reconstruction information includes 3D initial position/pose information of the depth camera and scene graph information.

4. The high-precision 3D geometry reconstruction method of claim 3, wherein the pre-trained multiple deep learning models comprise a deblur deep learning model configured to remove blurring in the multi-view RGBD data, a camera position/pose precision enhancement deep learning model configured to correct a camera position and pose by entirely utilizing the multi-view RGBD data, and a Gaussian optimization deep learning model configured to enhance precision of 3D reconstructed geometry using a result of 3D Gaussian rendering.

5. The high-precision 3D geometry reconstruction method of claim 4, wherein the camera position/pose precision enhancement deep learning model corrects a camera position transformation matrix such that a sum of losses produced by a loss function between nodes of the scene graph information is minimized.

6. The high-precision 3D geometry reconstruction method of claim 5, wherein the camera position transformation matrix is a matrix that projects an N-th camera coordinate system corresponding to camera position/pose information of N-th RGBD input data onto an (N+1)-th camera coordinate system corresponding to camera position/pose information of (N+1)-th RGBD input data.

7. The high-precision 3D geometry reconstruction method of claim 6, wherein the loss function is set such that a value matching the (N+1)-th RGBD input data is obtained by multiplying the camera position transformation matrix by the N-th RGBD input data.

8. The high-precision 3D geometry reconstruction method of claim 4, wherein the Gaussian optimization deep learning model repeatedly performs operations of converting the multi-view RGBD data into a Gaussian, generating a 3D Gaussian by flattening the Gaussian along a normal direction, and optimizing a Gaussian parameter so that a result of rendering the 3D Gaussian becomes similar to the multi-view RGBD data.

9. The high-precision 3D geometry reconstruction method of claim 8, wherein the Gaussian parameter includes a position, a color, a rotation value for determining orientation of placement, size values along X, Y, and Z axes, and a density value for transparency.

10. A high-precision three-dimensional (3D) geometry reconstruction apparatus, comprising:
a processor configured to obtain multi-view RGBD data by capturing a reconstruction target, estimate initial reconstruction information in real time using the multi-view RGBD data, enhance precision of the initial reconstruction information by performing blur removal, camera position/pose precision enhancement, and 3D geometry precision enhancement based on pre-trained multiple deep learning models, perform 3D rendering or mesh conversion on precision-enhanced reconstruction information, and store 3D-rendered or mesh-converted reconstruction information; and
a memory configured to store the pre-trained multiple deep learning models and the 3D-rendered or mesh-converted reconstruction information.

11. The high-precision 3D geometry reconstruction apparatus of claim 10, wherein the multi-view RGBD data corresponds to data, obtained by capturing an object or a space corresponding to the reconstruction target at various angles and positions, based on a depth camera capable of capturing RGBD data.

12. The high-precision 3D geometry reconstruction apparatus of claim 11, wherein the initial reconstruction information includes 3D initial position/pose information of the depth camera and scene graph information.

13. The high-precision 3D geometry reconstruction apparatus of claim 12, wherein the pre-trained multiple deep learning models comprise a deblur deep learning model configured to remove blurring in the multi-view RGBD data, a camera position/pose precision enhancement deep learning model configured to correct a camera position and pose by entirely utilizing the multi-view RGBD data, and a Gaussian optimization deep learning model configured to enhance precision of 3D reconstructed geometry using a result of 3D Gaussian rendering.

14. The high-precision 3D geometry reconstruction apparatus of claim 13, wherein the camera position/pose precision enhancement deep learning model corrects a camera position transformation matrix such that a sum of losses produced by a loss function between nodes of the scene graph information is minimized.

15. The high-precision 3D geometry reconstruction apparatus of claim 14, wherein the camera position transformation matrix is a matrix that projects an N-th camera coordinate system corresponding to camera position/pose information of N-th RGBD input data onto an (N+1)-th camera coordinate system corresponding to camera position/pose information of (N+1)-th RGBD input data.

16. The high-precision 3D geometry reconstruction apparatus of claim 15, wherein the loss function is set such that a value matching the (N+1)-th RGBD input data is obtained by multiplying the camera position transformation matrix by the N-th RGBD input data.

17. The high-precision 3D geometry reconstruction apparatus of claim 13, wherein the Gaussian optimization deep learning model repeatedly performs operations of converting the multi-view RGBD data into a Gaussian, generating a 3D Gaussian by flattening the Gaussian along a normal direction, and optimizing a Gaussian parameter so that a result of rendering the 3D Gaussian becomes similar to the multi-view RGBD data.

18. The high-precision 3D geometry reconstruction apparatus of claim 17, wherein the Gaussian parameter includes a position, a color, a rotation value for determining orientation of placement, size values along X, Y, and Z axes, and a density value for transparency.
